(19) United States
(12) Patent Application Publication
(10) Pub. No.: US 2015/0298050 A1
(43) Pub. Date: Oct. 22, 2015

(54) ROTARY REGENERATIVE SCRUBBER WITH PINION GEAR AND SPUR GEAR DRIVE ARRANGEMENT

(71) Applicant: CARRIER CORPORATION, Farmington, CT (US)

(72) Inventor: Curtis Richardson, Newark, NY (US)

(21) Appl. No.: 14/440,836

(22) PCT Filed: Sep. 11, 2013
(86) PCT No.: PCT/US2013/059130

§ 371 Date: May 5, 2015

Related U.S. Application Data
(60) Provisional application No. 61/725,633, filed on Nov. 13, 2012.

(51) Int. Cl. B01D 53/06; A23B 7/152; A23L 3/3409; F16H 1/06

(52) U.S. Cl. CPC B01D 53/06; F16H 1/06; A23B 7/152; A23L 3/34095; B01D 2257/504

(57) ABSTRACT

A rotary regenerative scrubber includes a rotor assembly and a pinion gear and spur gear drive arrangement for rotating the rotor assembly. The drive arrangement includes a spur gear extending circumferentially about an exterior surface of the rotor assembly, a pinion gear engaging the spur gear in intermeshing drive relationship, and a motor for driving the pinion gear.

### BACKGROUND

This disclosure relates generally to driving a rotating regenerative device and, more particularly, to a drive arrangement for rotating a rotary regenerative scrubber for removing a selected component of a gas flow from a closed space, for example for removing carbon dioxide from the atmosphere within a cargo space of a refrigerated transport container.

Perishable goods are commonly transported in a controlled environment within an enclosed space such as a cargo box of a truck, trailer, sea container, or intermodal container. Certain perishable produce, such as fresh fruits, vegetables and flowers, produce carbon dioxide as a product of the respiration process. In a closed environment, due to post harvest respiration, the carbon dioxide concentration rises and the oxygen concentration drops in the atmosphere within the closed environment. If the oxygen concentration gets too low or the carbon dioxide concentration gets too high, the produce can spoil. Additionally, certain fruits and vegetables and flowers release ethylene and/or ethylene compounds as a byproduct of the ripening process. The presence of ethylene based gases within the enclosed space of the cargo box is known to accelerate the ripening process.

It is known to remove carbon dioxide from the atmosphere within an enclosed space by passing the gas from within the enclosed space through a non-regenerative bed of carbon dioxide adsorbent to scrub carbon dioxide from the gas passing through the adsorbent bed. However non-regenerative systems lose scrubbing efficiency as the adsorbent bed becomes saturated and the carbon dioxide adsorbent material must be replaced. Therefore, such non-regenerative systems have limited application, particularly in the long haul transport of perishable produce.

### SUMMARY

In an aspect, a rotary regenerative scrubber is provided for removing a selected gaseous component from a flow of gas to be cleaned that is a compact package.

The rotary regenerative scrubber includes a housing defining a chamber having a first flow passage for a flow of gas to be cleaned and a second flow passage for a flow of regenerating gas, a rotor assembly disposed within the chamber for rotation through the first flow passage and the second flow passage, and a pinion gear and spur drive arrangement for rotating the rotor assembly about an axis. In an embodiment, the pinion gear and spur gear drive arrangement may include a spur gear extending circumferentially about an exterior surface of the rotor assembly, a drive motor mounted to the housing, the rotor having a drive shaft into the chamber, and a pinion gear mounted to a distal end of the drive shaft and engaging the spur gear in intermeshing drive relationship. The spur gear may be formed integrally with a rotor of the rotor assembly. The drive motor may be a DC brushless motor

### BRIEF DESCRIPTION OF THE DRAWINGS

For a further understanding of the disclosure, reference will be made to the following detailed description which is to be read in connection with the accompanying drawing, wherein:

FIG. 1 is a perspective view of an embodiment of a rotary regenerative scrubber;

FIG. 2 is an exploded perspective view of the embodiment of the rotary regenerative scrubber depicted in FIG. 1; and

FIG. 3 is a sectioned elevation view of the rotary regenerative scrubber of FIG. 1.

### DETAILED DESCRIPTION

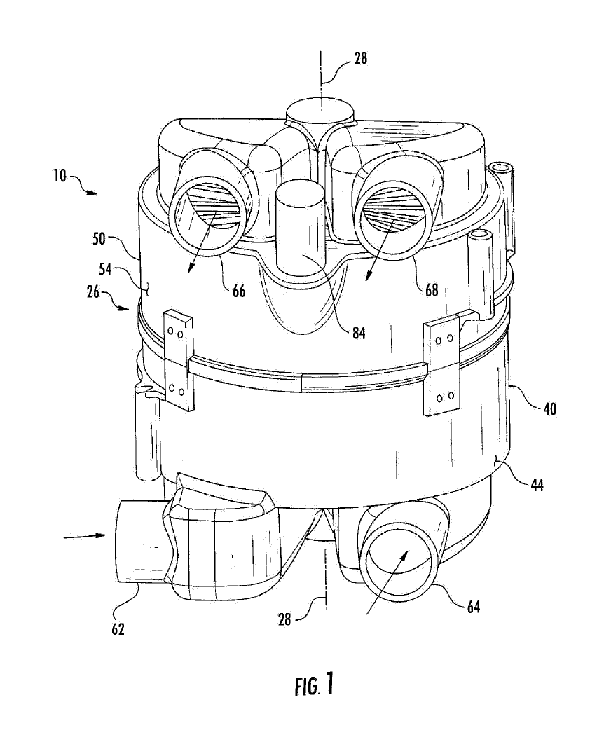

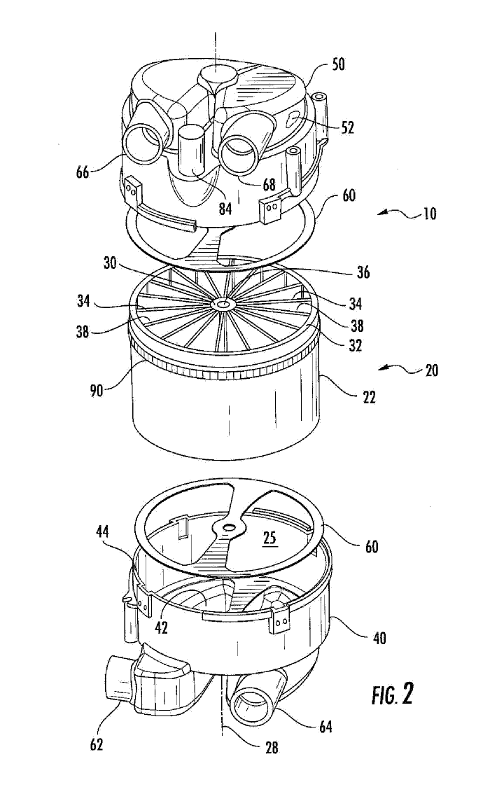

Referring initially to FIGS. 1 and 2, there is depicted an exemplary embodiment of a rotary regenerative scrubber 10 having a rotor assembly 20 disposed within a housing 26. The rotor assembly 20 is driven in rotation about an axis 28 by a drive arrangement as disclosed herein and described in further detail hereinafter.

The housing 26 includes a first housing section 40 and a second housing 50. In the depicted embodiment wherein the rotary regenerative scrubber 10 is shown as vertically orientated, the first housing section 40 forms a lower housing and the second housing section 50 forms an upper housing. It is to be understood, however, that the rotary regenerative scrubber 10 may be orientated for rotation about an axis other than a vertical axis, such as a horizontal axis or otherwise orientated axis, as desired.

When the first and second housing sections 40, 50 are assembled in mating relationship as depicted in FIG. 1, the respective chamber walls 44, 54 come together to define an interior chamber 25 (see FIG. 2) within the housing 26 in which the rotor assembly 20 is disposed. The first housing section 40 also defines a gas manifold 42 (see FIG. 2) positioned beneath the interior chamber in the depicted vertically oriented embodiment. Similarly, the second housing section defines a gas manifold 52 (see FIG. 2) positioned above the interior chamber 25 in the depicted vertically oriented embodiment. The first housing section 40 further includes a connector 62 opening in fluid communication with a first plenum within the gas manifold 42 for the regenerative gas and a second connector 64 opening in fluid communication with a second plenum within the gas manifold 42, separated from the first plenum, for the gas to be cleaned. Similarly, the second housing section 50 further includes a connector 66 opening in fluid communication with a first plenum within the gas manifold 52 for the regenerative gas and a second connector 68 opening in fluid communication with a second plenum within the gas manifold 52, separated from the first plenum, for the gas to be cleaned. When the first and second housing sections 40 and 50 are assembled together, the respective first plenums for the regenerative gas are in fluid communication via a first gas flow passage through the chamber 25 in which the rotor 22 is disposed. Similarly, the respective second plenums for the gas to be cleaned are in fluid communication via a second gas flow passage through the chamber 25.

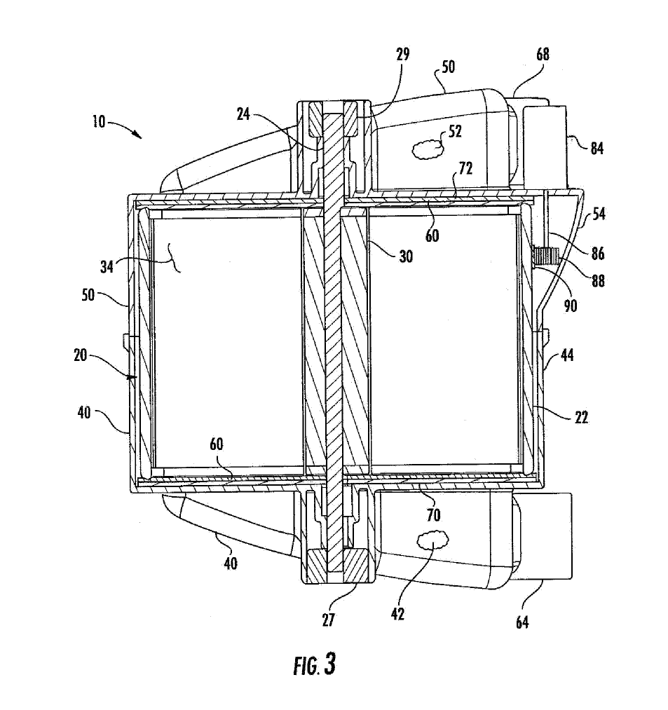

Referring now also to FIG. 3, the rotor assembly 20 includes a rotor 22, also referred to as a carousel, mounted to a shaft 24. The rotor assembly 20 is disposed within a stationary housing 26 for rotation with the shaft 24 about a longitudinal axis 28 of the shaft 24. The rotor 22 carries an adsorbent material capable of adsorbing a selected gaseous component or components from a flow of gas passing through the adsorbent material. The rotor 22 includes a central hub 30, a circumferential wall 32 and a plurality of radially directed partitions 34 extending from the hub 30 to the circumferential wall 32. The hub 30 has a central hole 36 extending axially therethrough for receiving the shaft 24 to which the rotor 22 is mounted for rotation with the shaft 24. The plurality of partitions 34 divide the volume defined by the rotor 22 into a plurality of wedge-shaped sectors 38. Adsorbent material capable of adsorbing the selected gas component or components to be removed is disposed in each sector 38. An end face seal gasket 60 may be disposed between each end of the rotor assembly 20 and an interfacing surface of each of the first housing section 40 and the second housing section 50.

One of the second plenums serves as an inlet plenum for receiving a flow of gas to be cleaned and the other of the second plenums serves as an outlet plenum through which a flow cleaned gas is discharged. One of the first plenums serves as an inlet plenum for receiving a flow of regenerative gas and the other of the first plenums serves as an outlet plenum through which the regenerative gas is discharged. In the embodiment depicted in drawings, the first plenum of the gas manifold 42 of the first housing section 40 is an inlet plenum receiving the flow of regenerative gas through connector tube 62, the second plenum of the gas manifold 42 of the first housing section 40 is an inlet plenum receiving the flow of gas to be cleaned through connector tube 64, the first plenum of the gas manifold 52 of the second housing section 50 is an outlet plenum through which the flow of regenerative gas discharges through the connector 66, and the second plenum of the gas manifold 52 of the second lousing section 50 is an outlet plenum through which the flow of the cleaned gas discharges through connector 68.

Further details of the rotary regenerative scrubber 10 described herein are presented in co-pending International patent application no. PCT/US2012/46138, filed Jul. 11, 2012, and entitled ROTATING REGENERATIVE SCRUBBER AND SEALING ARRANGEMENT, the entire disclosure of which is hereby incorporated herein by reference. The aforesaid International patent application is assigned to Carrier Corporation, the same entity to which this application is subject to assignment.

As noted previously, the rotor 22 of the rotary regenerative scrubber 10 carries a regenerative adsorbent material capable of adsorbing the selected gaseous component or components to be removed from the gas to be cleaned. A regenerative adsorbent material is an absorbent material whose adsorbent capacity may be restored by desorbing the adsorbed gaseous component from the adsorbent material. The absorbent material may be in any form and disposed in the rotor in any manner suitable to be carried in the wedge-shaped sectors 38 of the rotor 22.

The rotary regenerative scrubber 10 disclosed herein is suitable for, but limited in application to, use in removing carbon dioxide from a flow of cargo box air drawn from the cargo box of a refrigerated transport container, such as a truck, a trailer, a sea-going container, or an intermodal container. Therefore, as an example, the operation of the rotary regenerative scrubber 10 will be described in application to removing carbon dioxide from air drawn from the cargo box of a container transporting a perishable product that emits carbon dioxide as a respiration by-product. In such application, the adsorbent material may comprise any carbon dioxide adsorbent material that can be regenerated by contacting fresh air with the carbon dioxide adsorbent material to desorbed adsorbed carbon dioxide and carry the desorbed carbon dioxide away.

In operation of the rotary regenerative scrubber 10 depicted in FIGS. 1-3 with the rotor 22 carrying a regenerative carbon dioxide adsorbent material, carbon dioxide bearing air drawn from the closed environment within the cargo box and passed through the connector 64 into the second plenum of the gas manifold 42 of the first housing section 40, thence through the rotor 22 into the second plenum of the gas manifold 52 of the second housing section 50 to discharge through the connector 68. Simultaneously, to regenerate the carbon dioxide adsorbent material, fresh air is passed through the connector 62 into the first plenum of the gas manifold 42 of the first housing section 40, thence through the rotor 22 into the first plenum of the gas manifold 52 of the second housing section 50 to discharge through the connector 66.

As the regenerative gas and the gas to be cleaned pass through the scrubber 10, the rotor 22 is driven in rotation with the shaft 24 about the axis 28 extending longitudinally through the shaft 24. To facilitate rotation of the rotor assembly 20, the distal ends of the shaft 24 are supported in bearings 27, 29 mounted in the first housing section 40 and the second housing section 50, respectively. As the rotor assembly 20 is rotated about the axis 28, the adsorbent material disposed within the compartments 34 passes through the flow to be cleaned of the selected gas and then passes through a flow of air for regenerating the adsorbent material by removing the adsorbed selected gas from the adsorbent material.

Referring now to FIG. 3 in particular, there is depicted therein a drive arrangement is provided for driving the rotor assembly 20 within the chamber 25 in rotation about the axis 28. The drive arrangement includes a drive motor 84 having a drive shaft 86, a pinion gear 88 mounted on a distal end of the drive shaft 86, and a spur gear 90 on the external wall of the rotor 22. The spur gear 90 extends around the entire circumference of the outer circumference wall of the rotor 26, as illustrated in FIG. 2. The spur gear 90 may be formed integrally with the rotor 26, for example by extrusion, investing casting, die casting or otherwise, or may be separately fabricated and then bonded to the outer circumferential wall of the rotor 26, for example by welding otherwise depending upon the particular material/materials of which the spur gear and the rotor are formed.

The pinion gear 88 engages the spur gear 90 with the teeth of the pinion gear and the teeth of the spur gear in an intermeshing relationship whereby rotation of the pinion gear 88 drives the spur gear 90 thereby causing rotation of the rotor assembly 20. The pinion gear 88 has a first plurality of teeth and the spur gear 90 has a second plurality of teeth, the second plurality of teeth being greater in number than the first plurality of teeth. The drive motor 84 is mounted upon the outer surface of the base of the second housing section 50 with the drive shaft 86 penetrating through the base of the second housing section 50 and extending into the chamber 25. However, although shown mounted upon the base of the second housing section 50 in the depicted embodiment, it is to be understood that the drive motor 84 could be mounted instead upon the base of the first housing section 40.

The drive motor 84 may be any suitable motor. In an embodiment, the motor 84 may be a DC brushless motor. A DC brushless motor, or other spark-less motor, may be desired when the gas to be cleaned is ethylene, a by-product of the respiration during transport of certain produce, such as bananas. In an embodiment of the rotary regenerative scrubber 10, the motor 84 may be a 12-volt or a 24-volt DC, 50 rpm DC brushless motor. In an embodiment, gear ratio between the spur gear 90 and the pinion gear 88 may be 25 to 1, although other gear ratios may be selected as desired.

The pinion gear and spur gear drive arrangement disclosed herein has multiple benefits over a conventional drive arrangement wherein the rotor shaft 24 extends through the housing 26 to be directly driven by a motor mounted on the drive shaft. For example, the pinion gear and spur gear drive arrangement disclosed herein permits the overall height of the rotary regenerative scrubber 10 to be reduced resulting in a more compact package.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention.

Therefore, it is intended that the present disclosure not be limited to the particular embodiment(s) disclosed as, but that the disclosure will include all embodiments falling within the scope of the appended claims.

We claim:

1. A rotary regenerative scrubber for removing a selected gaseous component from a flow of gas to be cleaned, the scrubber comprising:
a housing defining a chamber having a first flow passage for a flow of gas to be cleaned and a second flow passage for a flow of regenerating gas;
a rotor assembly disposed within the chamber for rotation through the first flow passage and the second flow passage, the rotor assembly carrying a regenerative material capable of removing the selected gaseous component; and
a pinion gear and spur gear drive arrangement for rotating the rotor assembly about an axis.

2. The rotary regenerative scrubber as recited in claim 1 wherein the pinion gear and spur gear drive arrangement comprises:
a spur gear extending circumferentially about an exterior surface of the rotor assembly;
a drive motor mounted to the housing, the rotor having a drive shaft into the chamber; and
a pinion gear mounted to a distal end of the drive shaft, the pinion gear engaging the spur gear in intermeshing drive relationship.

3. The rotary regenerative scrubber as recited in claim 2 wherein the spur gear is formed integrally with a rotor of the rotor assembly.

4. The rotary regenerative scrubber as recited in claim 2 wherein the drive motor comprises a DC brushless motor.

5. The rotary regenerative scrubber as recited in claim 1 wherein the rotor assembly carries a regenerative absorbent material capable of adsorbing carbon dioxide gas.
